(19) United States
(12) Patent Application Publication
(10) Pub. No.: US 2023/0412751 A1
(43) Pub. Date: Dec. 21, 2023

(54) IMAGE PROCESSING APPARATUS, IMAGE PROCESSING METHOD, AND NON-TRANSITORY COMPUTER-READABLE STORAGE MEDIUM STORING PROGRAM

(71) Applicant: CANON KABUSHIKI KAISHA, Tokyo (JP)

(72) Inventors: YOSHINORI MIZOGUCHI, Tokyo (JP); HISASHI ISHIKAWA, Chiba (JP); AKITOSHI YAMADA, Kanagawa (JP)

(21) Appl. No.: 18/331,427

(22) Filed: Jun. 8, 2023

(30) Foreign Application Priority Data
Jun. 15, 2022 (JP) 2022-096751

(51) Int. Cl. H04N 1/40

(52) U.S. Cl. CPC H04N 1/40087

(57) ABSTRACT

A quantization unit executes quantization processing for first print data corresponding to a first scan using a first threshold matrix and a third threshold matrix, and executes the quantization processing for second print data corresponding to a second scan using a second threshold matrix and a fourth threshold matrix, and a first degree that a dot arrangement that is a result of quantization using the third threshold matrix and a dot arrangement that is a result of quantization using the fourth threshold matrix hold an exclusive relationship is smaller than a second degree that a dot arrangement that is a result of quantization using the first threshold matrix and a dot arrangement that is a result of quantization using the second threshold matrix hold the exclusive relationship.

### BACKGROUND OF THE INVENTION

### Field of the Invention

The present invention relates to an image processing apparatus, an image processing method, and a non-transitory computer-readable storage medium storing a program.

### Description of the Related Art

When a printing apparatus prints an image using pseudo halftoning, multivalued image data needs to be quantized. As a generation method of a quantized image to be used at this time, an error diffusion method or a dither method is known. In particular, the dither method that decides printing or non-printing of a dot by comparing a threshold stored in advance with a tone value of multivalued data is burdened with a small processing load as compared to the error diffusion method and is therefore used in many image processing apparatuses.

In multivalued quantization using dither, various image quality improvements have been attempted in association with graininess in a state in which dots are ideally arranged. For example, under an environment where a printhead scans a plurality of times, a deviation occurs between scans (to be referred to as an inter-scan misregistration hereinafter) concerning a landing position on a print medium. Improvement is required about simultaneously implementing graininess associated with the deviation of the landing position of a dot in an actual printing operation and robustness to the deviation. Japanese Patent Laid-Open No. 2015-66943 describes coping with an inter-scan misregistration by, according the density of an input signal, designing a threshold matrix between scans in advance in consideration of robustness. Japanese Patent Laid-Open No. 2017-38127 describes setting a threshold matrix for each of a plurality of color materials.

### SUMMARY OF THE INVENTION

The present invention provides an image processing apparatus that suppresses image quality deterioration to an inter-scan misregistration, an image processing method, and a non-transitory computer-readable storage medium storing a program.

The present invention in one aspect provides an image processing apparatus comprising: an input unit configured to input image data; a generation unit configured to generate, from the image data input by the input unit, print data to be used in each of a plurality of scans of a printing unit; an acquisition unit configured to acquire a threshold matrix based on a tone value represented by the image data; and a quantization unit configured to execute quantization processing for the print data using the threshold matrix acquired by the acquisition unit, wherein if the tone value is included in a first range, the acquisition unit acquires a first threshold matrix corresponding to a first scan of the plurality of scans and acquires a second threshold matrix corresponding to a second scan, and if the tone value is included in a second range on a higher tone side of the first range, the acquisition unit acquires a third threshold matrix corresponding to the first scan and acquires a fourth threshold matrix corresponding to the second scan, the quantization unit executes the quantization processing for first print data corresponding to the first scan using the first threshold matrix and the third threshold matrix, and executes the quantization processing for second print data corresponding to the second scan using the second threshold matrix and the fourth threshold matrix, and a first degree that a dot arrangement that is a result of quantization using the third threshold matrix and a dot arrangement that is a result of quantization using the fourth threshold matrix hold an exclusive relationship is smaller than a second degree that a dot arrangement that is a result of quantization using the first threshold matrix and a dot arrangement that is a result of quantization using the second threshold matrix hold the exclusive relationship.

According to the present invention, it is possible to suppress image quality deterioration to an inter-scan misregistration.

Further features of the present invention will become apparent from the following description of exemplary embodiments with reference to the attached drawings.

### BRIEF DESCRIPTION OF THE DRAWINGS

FIG. 1 is a block diagram showing the configuration of control of a printing system;

FIG. 2 is a side sectional view for explaining the configuration of the printing unit of a printing apparatus;

FIG. 3 is a view showing a printhead viewed from a nozzle surface side;

FIG. 4 is a flowchart showing processing of image data;

FIG. 5 is a block diagram showing a configuration for executing scan count division processing and quantization processing;

FIG. 6 is a flowchart showing quantization processing;

FIG. 7 is a view showing quantization results;

FIGS. 8A and 8B are views for explaining unevenness improvement;

FIGS. 9A and 9B are views for explaining unevenness improvement;

FIG. 10 is a view showing a state in which a misregistration occurs;

FIGS. 11A and 11B are views for explaining processing of threshold matrix candidate selection;

FIG. 12 is a flowchart showing selection processing of a threshold matrix;

FIG. 13 is a view for explaining the feature of an occurrence probability of dot-on-dot;

FIGS. 14A and 14B are views for explaining the influence of a misregistration between scans;

FIGS. 15A and 15B are views for explaining the influence of a misregistration between scans;

FIGS. 16A and 16B are views for explaining selection of threshold matrices corresponding to an input tone value;

FIGS. 17A and 17B are views for explaining threshold matrix candidate selection;

FIG. 18 is a flowchart showing quantization processing;

FIG. 19 is a view for explaining selection of threshold matrices corresponding to an input tone value; and

FIGS. 20A to 20C are views for explaining selection of threshold matrices corresponding to an input tone value.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

The degree of an inter-scan misregistration can change depending on various print conditions. It is therefore assumed that a threshold matrix is prepared in accordance with each print condition.

According to the present disclosure, it is possible to suppress image quality deterioration to an inter-scan misregistration.

### First Embodiment

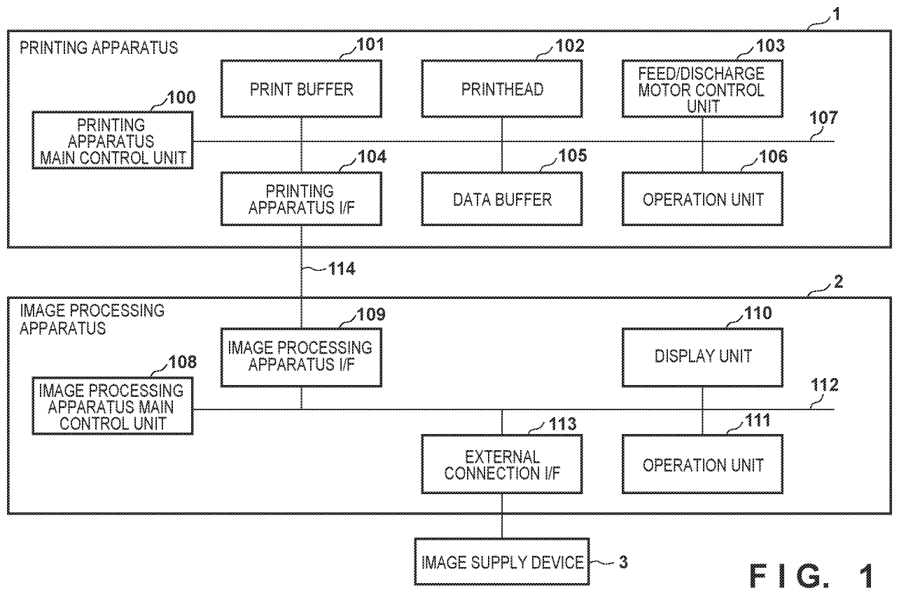

FIG. 1 is a block diagram showing an example of the configuration of control of a printing system applicable to this embodiment. The printing system according to this embodiment is configured to include an image supply apparatus 3, an image processing apparatus 2, and an inkjet printing apparatus 1 (to be also simply referred to as a printing apparatus hereinafter). Image data supplied from the image supply apparatus 3 undergoes predetermined image processing by the image processing apparatus 2, and is then sent to the printing apparatus 1 so as to be printed on a print medium.

In the printing apparatus 1, a printing apparatus main control unit 100 controls the entire printing apparatus 1, and is configured to include a CPU, a ROM, a RAM, and the like. A print buffer 101 stores image data before transfer to a printhead 102 as raster data. The printhead 102 is an inkjet printing type printhead including a plurality of nozzles capable of discharging ink droplets, and discharges ink from each nozzle in accordance with the image data stored in the print buffer 101. In this embodiment, as an example, nozzle arrays of four colors including cyan, magenta, yellow, and black are arranged on the printhead 102.

A paper feed/discharge motor control unit 103 controls conveyance of a print medium and paper feed/discharge, and controls the position of the print medium to make each ink droplet discharged from the printhead 102 land at a correct position on the print medium. The paper feed/discharge motor control unit 103 can execute a start/stop operation of a motor in consideration of a case where the printhead 102 performs scan a plurality of times.

A printing apparatus interface (I/F) 104 transmits/receives a data signal to/from the image processing apparatus 2. An I/F signal line 114 connects the printing apparatus 1 and the image processing apparatus 2. As a type of the I/F signal line 114, for example, an I/F signal line of specifications of Centronics can be applied. A data buffer 105 temporarily stores image data received from the image processing apparatus 2. An operation unit 106 includes a mechanism configured to accept a command operation by a user such as a developer. A system bus 107 connects the functional blocks of the printing apparatus 1 to each other.

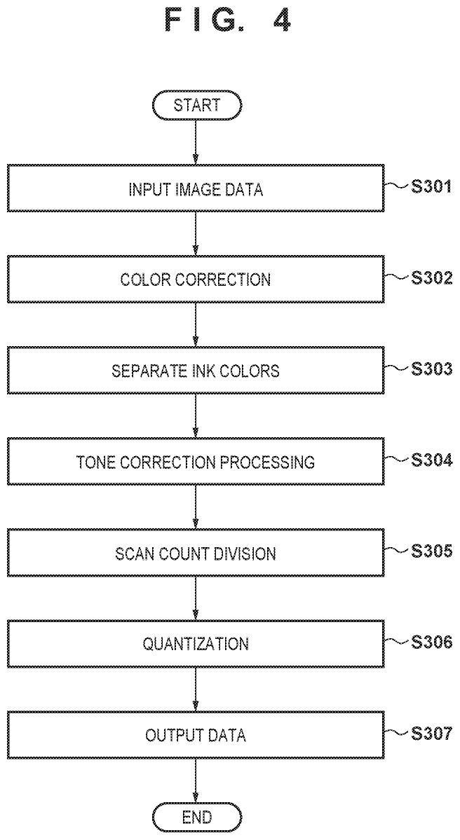

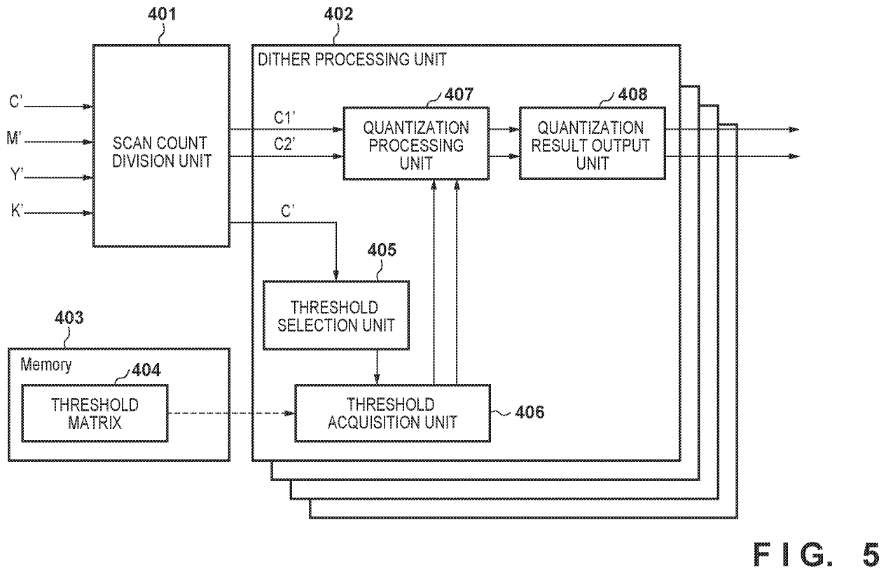

In the image processing apparatus 2, an image processing apparatus main control unit 108 performs various processes for image data supplied from the image supply apparatus 3, thereby generating image data printable by the printing apparatus 1. The image processing apparatus main control unit 108 is configured to include a CPU, a ROM, a RAM, and the like. The image processing apparatus main control unit 108 may be formed by a device different from the main body of the printing apparatus 1, as shown in FIG. 1, or may be formed in the main body of the printing apparatus 1. Note that a quantization configuration shown in FIG. 5 to be described later is provided in the image processing apparatus main control unit 108, and a flowchart to be described with reference to FIG. 4 is executed by the CPU of the image processing apparatus main control unit 108. A threshold matrix of dither to be used in quantization processing is stored in the ROM of the image processing apparatus main control unit 108 in advance. An image processing apparatus interface (I/F) 109 transmits/receives a data signal to/from the printing apparatus 1. An external connection interface (I/F) 113 transmits/receives image data and the like to/from the externally connected image supply apparatus 3. A display unit 110 displays various kinds of information to the user and, for example, an LCD or the like can be applied. An operation unit 111 is a mechanism configured to accept a command operation from the user and, for example, a keyboard or a mouse can be applied. A system bus 112 connects the functional blocks of the image processing apparatus 2 to each other.

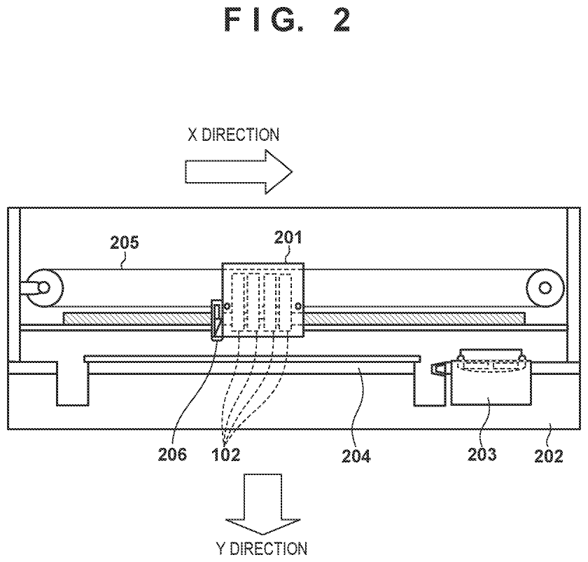

FIG. 2 is a side sectional view for explaining the configuration of the printing unit of the printing apparatus 1 usable in this embodiment. A carriage 201 on which the printhead 102 including nozzles corresponding to four ink colors and an optical sensor 206 are mounted can be moved reciprocally in the X direction of FIG. 2 by the driving force of a carriage motor transmitted via a belt 205. The reciprocal movement in the X direction is expressed as a scan count. When the printhead 102 discharges ink droplets in the Z direction in accordance with print data during the movement of the carriage 201 in the X direction relatively to a print medium, an image corresponding to one scan is printed on the print medium arranged on a platen 204.

Executing the movement in the X direction a plurality of times on the same region of a print medium is called “plural scans”. One of purposes of executing the plural scans is “to achieve a density”. That is, an ink discharge count for achieving a necessary density is implemented by a plurality of carriage scans. Another purpose is “to improve streaks/unevenness”. The discharge amounts of the nozzles provided in the printhead 102 may be slightly different. The discharge amount may be deviated by a tolerance in printer manufacturing or by continuous use. When printing is performed by plural scans, such a discharge amount difference can be made unnoticeable on a print medium. When print scan is performed a necessary number of times, the print medium is conveyed by a distance corresponding to the print width of one scan in the Y direction (conveyance direction) crossing the X direction in FIG. 2. When the movement of the printhead 102 in the X direction and the movement of the print medium in the Y direction are alternately repeated a plurality of times, an image is gradually formed on the print medium.

The optical sensor 206 performs a print medium detection operation while moving together with the carriage 201, thereby detecting a signal representing whether the print medium exists on the platen 204. A recovery unit 203 configured to perform maintenance processing of the printhead 102 is provided at a position in the scan region of the carriage 201 and outside the platen 204. As shown in FIG. 2, the carriage 201 discharges ink droplets while moving in the X direction. When movement in the X direction is stopped, the print medium is conveyed in the Y direction.

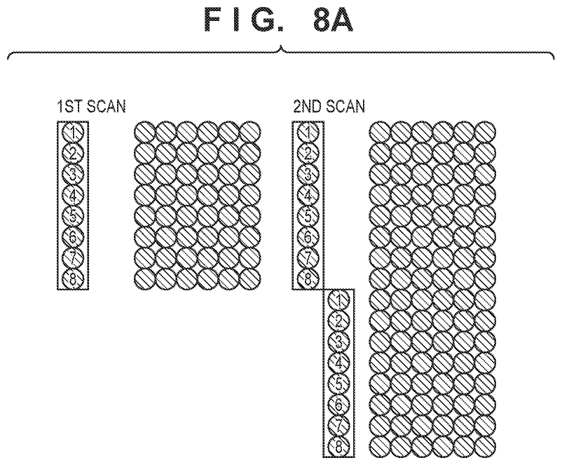

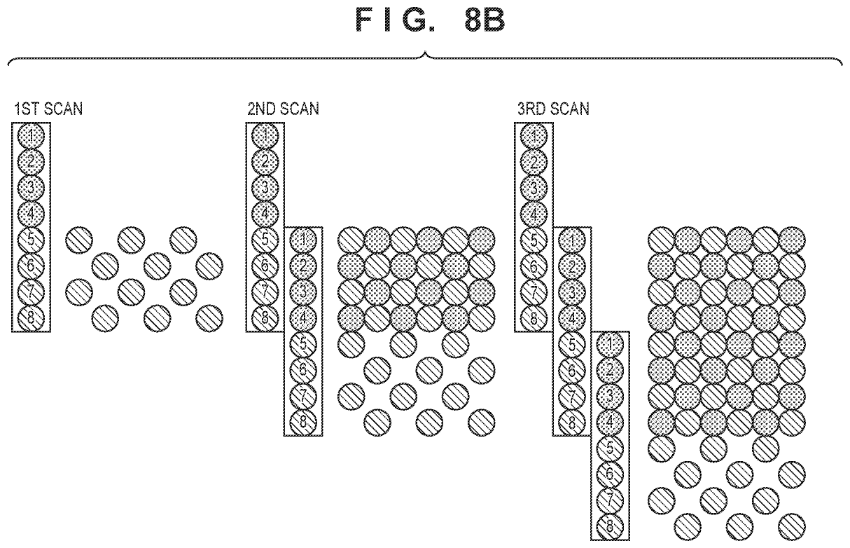

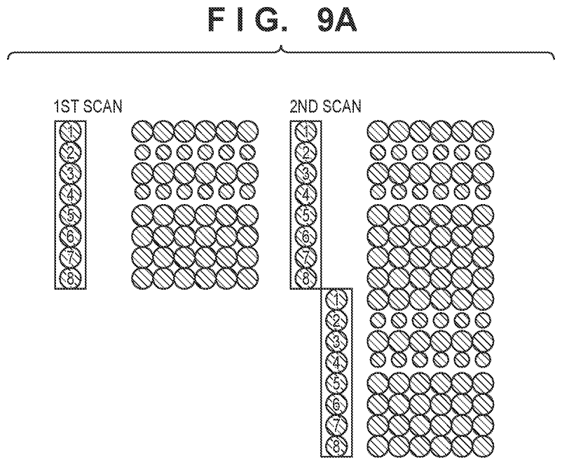

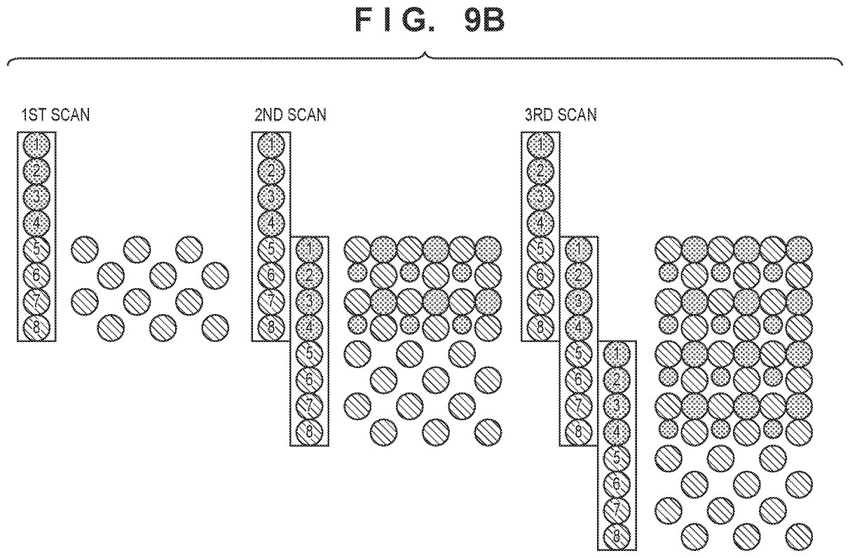

FIGS. 8A, 8B, 9A, and 9B are views showing examples of unevenness improvement by plural scans. In FIGS. 8A, 8B, 9A, and 9B, the printhead 102 includes nozzles of eight ink colors, and the nozzles are arranged at equal intervals in the Y direction in the printhead 102. FIGS. 8A and 9A each show a 1-scan configuration that completes discharge to the same region of a print medium by one scan. FIGS. 8B and 9B each show a plural-scan configuration that completes discharge to the same region of a print medium by two scans. As discriminately shown in FIGS. 8B and 9B, dark portions represent discharge results of nozzle 1 to 4, and light portions represent discharge results of those of nozzle 5 to 8. In fact, both nozzles are connected to ink tanks of the same color.

In FIGS. 8A and 8B, the discharge amounts of the eight nozzles are even. Hence, in the 1-scan configuration shown in FIG. 8A, dots are evenly arranged on a print medium, and unevenness does not occur. Unevenness does not occur in the plural-scan configuration shown in FIG. 8B as well. However, print productivity lowers as compared to FIG. 8A because the scan count is 2.

In FIGS. 9A and 9B, the discharge amount of the second and fourth nozzles in the eight nozzles is smaller than that of the peripheral nozzles. The discharge amount becomes small because the nozzle itself is formed narrow or because ink flying as a mist in air without permeating a print medium accumulates near a nozzle hole during repetitive discharge. Hence, the difference of the discharge amount may be generated at the time of manufacturing, depending on the use count, or depending on environmental conditions. In the 1-scan configuration shown in FIG. 9A, since, in the regions on the print medium where the second and fourth nozzles discharge ink, the discharge amount is small as compared to the peripheral dots, streaks/unevenness appear to occur at the two points. On the other hand, in the plural-scan configuration shown in FIG. 9B, in the region corresponding to the second nozzle, the sixth nozzle shares the density in the same Y direction, and in the region corresponding to the fourth nozzle, the eighth nozzle shares the density in the same Y direction. It is therefore possible to suppress the occurrence of streaks/unevenness. Although print productivity lowers as compared to FIG. 9A because the scan count is 2, the discharge amount differences between the nozzles can be averaged on the print medium. If a scan count with more discharge operations is set, the discharge amount differences are averaged more.

As described above, “streaks/unevenness improvement” can be achieved using the plural-scan configuration. On the other hand, when the plural-scan configuration is employed, an inter-scan misregistration readily occurs. For example, in the example of FIG. 9B, the second and sixth nozzles, and the fourth and eighth nozzles share the density with each other. When the nozzles sharing the density alternately discharge ink droplets, streaks/unevenness can be suppressed. However, if the position to which one of the nozzles discharges ink in the X direction relative to the print medium is deviated, strong unevenness occurs between the two scans.

FIG. 10 is a view showing a state in which a misregistration in the X direction occurs. As discriminately shown in FIG. 10, dark portions represent discharge results in the first scan, and light portions represent discharge results in the second scan, like FIG. 9. In fact, both nozzles are connected to ink tanks of the same color.

As shown in FIG. 10, the discharge results of the first scan and the discharge results of the second scan are at positions exclusive to each other. One of the viewpoints of evaluation of a print result is “graininess”. As conditions for high graininess, “dot arrangement separation” and “smoothness of lightness difference” are important. That is, it is preferable that along with the discharge of ink droplets to a blank region on a print medium, the white background of the print medium is filled, and the lightness is smoothed. Also, from the same viewpoint, it is necessary to prevent the lightness difference from the white background is enhanced because of overlap of dots before the white background of the print medium is filled. It can be said that FIG. 10 shows a desirable result in terms of “graininess”. When the “graininess” is high, the effect of making the dot arrangement unnoticeable in the print result can be obtained.

FIG. 10 shows a result in a case where a misregistration in the X direction occurs in the discharge of the second scan with respect to the result shown in FIG. 10. There are some pixels for which the ink is discharged outside the white background on the print medium, where the ink should originally be discharged, and is discharged in a superimposed manner for the place where the discharge of the first scan is already done. Since the white background appears, and the ink looks darker on the print medium because of superimposition, the lightness difference is enhanced, and “graininess” remarkably lowers. Employment of the plural-scan configuration thus leads to the occurrence of unevenness. Here, as an example, a misregistration in the X direction has been described. The same applies to an inter-scan misregistration in the Y direction.

The cause and the degree of influence of the inter-scan misregistration can change depending on a plurality of factors such as an accuracy error of the printer itself concerning landing/conveyance, the characteristics of a print medium, and the characteristics of ink. For example, spread of ink on a print medium changes depending on the features of the receiving layer of the print medium. An inter-scan misregistration becomes conspicuous because of overlap of a plurality of dots that should not overlap, and spread of ink on the print medium is associated with the influence of the inter-scan misregistration. If ink readily spreads, dots readily overlap in the inter-scan misregistration.

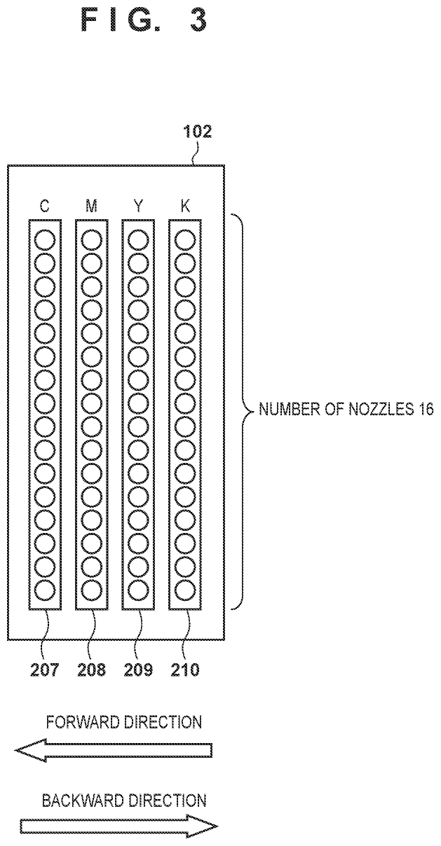

FIG. 3 is a view showing the printhead 102 viewed from the nozzle surface side. In the printhead 102, four nozzle arrays 207 to 210 are juxtaposed in the X direction. In each of the nozzle arrays 207 to 210, a plurality of (for example, 16) nozzles configured to discharge ink droplets are arrayed at a pitch of 1,200 dpi in a predetermined direction, that is, in the Y direction. The nozzle arrays 207 to 210 discharge C (cyan), M (magenta), Y (yellow), and K (black) inks, respectively.

FIG. 4 is a flowchart showing processing of image data performed by the image processing apparatus main control unit 108. This processing is implemented by the CPU provided in the image processing apparatus main control unit 108 reading out a program stored in the ROM and executing it. In step S301, image data of a pixel of interest that is a processing target is input from the image supply apparatus 3. In step S302, the image processing apparatus main control unit 108 executes color correction. The image data that the image processing apparatus 2 receives from the image supply apparatus 3 are brightness data of 8-bit R (red), G (green), and B (blue) components configured to express a standardized color space such as sRGB. In step S302, these brightness data are converted into brightness data of 8-bit RGB components corresponding to a color space unique to the printing apparatus 1. As a method of converting a signal value, a known method such as referring to a Look-Up Table (LUT) stored in the ROM or the like in advance may be used.

In step S303, the image processing apparatus main control unit 108 separates the RGB data after the conversion into tone data (density data) of C (cyan), M (magenta), Y (yellow), and K (black) which are the ink colors of the printing apparatus 1 and are each represented by 8 bits (256 values). At this stage, 8-bit gray images corresponding to four channels (four colors) are generated. In the ink color separation processing, an LUT stored in the ROM or the like may be used, like color correction processing.

In step S304, the image processing apparatus main control unit 108 performs tone correction processing for each of CMYK. In general, the number of dots printed on a print medium and optical brightness implemented on the print medium by the number of dots do not hold a linear relationship. Hence, to make the relationship linear, the multivalued color signal data CMYK are primarily converted to adjust the number of dots to be printed on the print medium. More specifically, by referring to a one-dimensional LUT prepared in correspondence with each ink color, CMYK data each represented by 8 bits (256 values) are converted into C′M′Y′K′ data each similarly represented by 8 bits (256 values).

In step S305, the image processing apparatus main control unit 108 performs scan count division according to the scan count of the printhead 102 for each pixel of C′M′Y′K′ data. As the scan count division, for example, an input tone value is equally divided to each scan. For example, if the input tone value of a pixel PIXi of C′ is 200, and the printhead 102 forms the density on the pixel PIXi by two scans, a tone value of 100 is assigned to the first scan (PIXi1), and a tone value of 100 is assigned to the second scan (PIXi2). Note that the method of scan count division is merely an example and is not limited to this method. By the process of step S305, C1′, C2′, . . . , CX′ are obtained from C′. X varies depending on the scan count. The same applies to data corresponding to the M ink, the Y ink, and the K ink.

In step S306, the image processing apparatus main control unit 108 performs predetermined quantization processing for C1′, C2′, . . . , CX′ to convert these into dot discharge data. The same applies to data corresponding to the M ink, the Y ink, and the K ink. The quantization processing in step S306 will be described later. In step S307, the image processing apparatus main control unit 108 outputs the dot discharge data converted in step S306. The processing shown in FIG. 4 thus ends.

FIG. 5 is a functional block diagram showing a configuration for executing scan count division processing in step S305 and quantization processing in step S306 in FIG. 4. The quantization processing according to this embodiment is performed by the dither method. A scan count division unit 401 acquires, for the ink colors, 8-bit multivalued tone data C′M′Y′K′ representing the density of each pixel and performs density division according to the scan count. Here, it is assumed that for a pixel that is a target, discharge is performed for a print medium divisionally by two scans. That is, for example, C′ is divided into C1′ and C2′. After the division is performed, the pieces of original multivalued information C′ and C1′ and C2′ are transferred to a dither processing unit 402. The same applies to data corresponding to the M ink, the Y ink, and the K ink. Processing in the dither processing unit 402 is performed concurrently for the inks. Here, processing for the C ink will be described as an example.

In the dither processing unit 402, the input multivalued data C1′ and C2′ to be quantized are directly transmitted to a quantization processing unit 407. On the other hand, a threshold selection unit 405 controls a threshold acquisition unit 406 using the information of the input multivalued data C′. The threshold acquisition unit 406 accesses a memory 403 and acquires an appropriate threshold matrix 404. The threshold acquisition unit 406 selects a dither threshold corresponding to the coordinates of the input multivalued data for each of C1′ and C2′ and transmits the dither thresholds to the quantization processing unit 407. Using the input multivalued data C1′ and a dither threshold Dth1 acquired from the threshold acquisition unit 406, the quantization processing unit 407 performs predetermined quantization processing and outputs quantized data. Also, using the input multivalued data C2′ and a dither threshold Dth2 acquired from the threshold acquisition unit 406, the quantization processing unit 407 performs predetermined quantization processing and outputs quantized data.

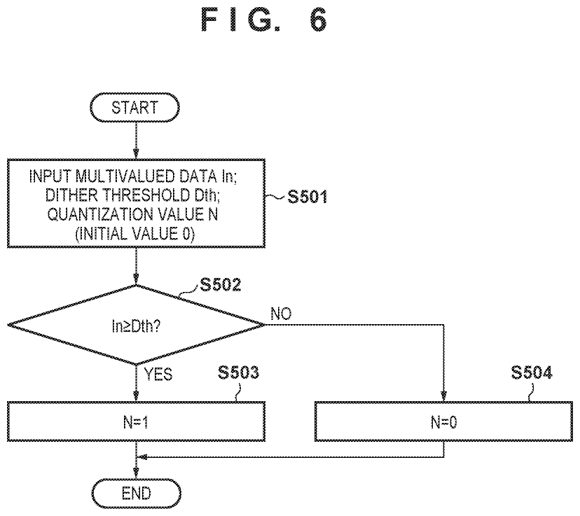

FIG. 6 is a flowchart for explaining quantization processing for one pixel, which is executed by the quantization processing unit 407 in the step of quantization processing. C1′ and C2′ are processed in accordance with the flowchart.

If input multivalued data In of one pixel is input, in step S501, the quantization processing unit 407 prepares a dither threshold Dth. The dither threshold Dth is a value arranged at a position corresponding to the coordinates (x, y) of the input multivalued data In in the threshold matrix 404 acquired by the threshold acquisition unit 406.

In step S502, the quantization processing unit 407 compares the input multivalued data In with the dither threshold Dth. If In≥Dth, the process advances to step S503 to set a quantization value N to 1, and the processing is ended. On the other hand, if In<Dth, the process advances to step S504 to maintain the quantization value N at 0, and the processing is ended. A dot is discharged for a pixel for which the quantization value is set to 1. No dot is discharged for a pixel for which the quantization value is set to 0.

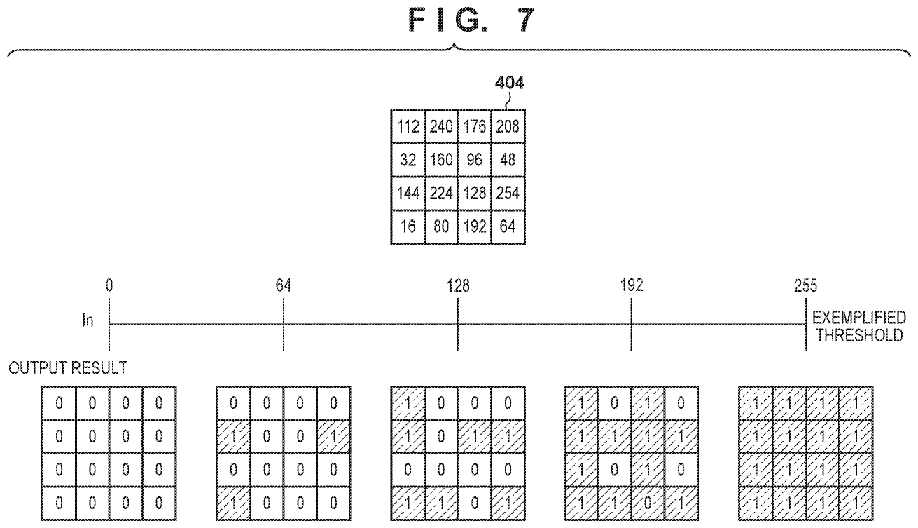

FIG. 7 is a view showing an example of quantization results obtained by executing the flowchart of FIG. 6. Quantization results for several input multivalued data In are shown in detail. When In=0, the quantization results of all pixels are 0. When In=255, the quantization results of all pixels are 1. When 0<In<255, quantization values “0” and “1” coexist. The quantization results are arranged in consideration of dispersity, and a density corresponding to input RGB data is reproduced on a print medium in accordance with the number of arranged quantization values “1”.

In this embodiment, as shown in FIG. 5, the dither threshold matrix is selected for each density divided for each scan. In this embodiment, robustness to an inter-scan misregistration can be obtained by selecting a threshold matrix.

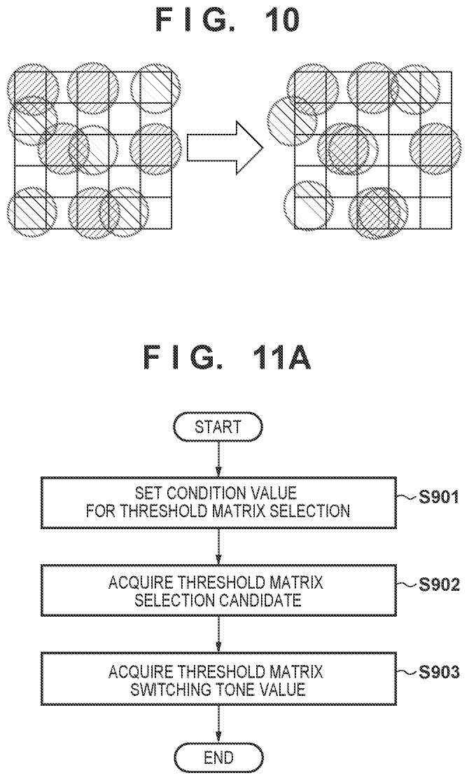

FIG. 11A is a flowchart showing threshold matrix candidate selection processing. When the threshold selection unit 405 instructs, and the execution contents of the program are interpreted in the threshold acquisition unit 406, each process shown in FIG. 11A is performed.

In step S901, the threshold acquisition unit 406 acquires condition values for threshold matrix selection. In this embodiment, the type of a print medium that is a print target and the scan speed of the printhead 102 are acquired as the condition values. For example, pieces of setting information (print conditions) such as print medium type=plain paper and scan speed of printhead 102=40 inches/sec are set. Acquisition of the condition values in step S901 may be done by, for example, acquiring these from contents set by the user. The scan speed of the printhead 102 may be held in an internal storage area in advance, or may be acquired from the printing apparatus 1.

In step S902, the threshold acquisition unit 406 acquires a threshold matrix selection candidate based on a correspondence table shown in FIG. 11B. For each scan, the information of a threshold matrix to be selected is acquired. In step S903, the threshold acquisition unit 406 acquires a threshold matrix switching tone value based on the correspondence table shown in FIG. 11B.

FIG. 11B is a view showing the correspondence table to be referred to by the threshold acquisition unit 406 in this embodiment. For example, in the correspondence table, a plurality of threshold matrices, that is, a first threshold matrix (to be referred to as (1)) and a second threshold matrix (to be referred to as (2)) are registered in correspondence with the setting information including the print medium type and the scan speed of the printhead 102. In this embodiment, two threshold matrices can be registered. However, the number of threshold matrices may be three or more. For example, if conditions such as print medium type=plain paper and scan speed of printhead 102=40 inches/sec are set, in step S902, a threshold matrix a is acquired for the first scan, and a threshold matrix b and a threshold matrix d are acquired for the second scan as the threshold matrix selection candidates. Also, in step S903, a switching tone value “80” is acquired. Which one of the first threshold matrix and the second threshold matrix is to be used is decided based on the switching tone value. Switching of the threshold matrix using the switching tone value will be described with reference to FIG. 12.

FIG. 12 is a flowchart showing selection processing of a threshold matrix according to an input tone value. When the threshold selection unit 405 instructs, and the execution contents of the program are interpreted in the threshold acquisition unit 406, the processing shown in FIG. 12 is performed. The selected threshold matrix is sent to the quantization processing unit 407.

In step S1001, the threshold acquisition unit 406 performs determination processing using the input tone value input by the threshold selection unit 405 and the switching tone value acquired in step S903. That is, if the input tone value is smaller than the switching tone value, the process advances to step S1002. If the input tone value is equal to or larger than the switching tone value, the process advances to step S1005.

In step S1002, the threshold acquisition unit 406 executes loop processing as many times as the scan count. In step S1003, the threshold acquisition unit 406 selects, for a scan count X, a threshold matrix registered as the first threshold matrix for a row corresponding to setting information in the correspondence table shown in FIG. 11B. For example, in a case where setting information includes print medium type=plain paper and scan speed of printhead 102=40 inches/sec, and the input tone value is 50, since input tone value “50”<switching tone value “80”, the process advances to step S1002. Then, the threshold matrix a is selected for the first scan, and the threshold matrix b is selected for the second scan.

In step S1004, the threshold acquisition unit 406 performs termination processing of the loop processing of step S1002. That is, if the loop processing is not executed as many times as the scan count, the process returns to step S1002.

On the other hand, in step S1005, the threshold acquisition unit 406 executes loop processing as many times as the scan count. In step S1006, the threshold acquisition unit 406 selects, for the scan count X, a threshold matrix registered as the second threshold matrix for a row corresponding to setting information in the correspondence table shown in FIG. 11B. For example, in a case where setting information includes print medium type=plain paper and scan speed of printhead=40 inches/sec, and the input tone value is 100, since input tone value “100”>switching tone value “80”, the process advances to step S1005. Then, the threshold matrix a is selected for the first scan, and the threshold matrix d is selected for the second scan.

In step S1007, the threshold acquisition unit 406 performs termination processing of the loop processing of step S1005. That is, if the loop processing is not executed as many times as the scan count, the process returns to step S1005.

In this above-described way, the threshold matrix for each scan can be selected in accordance with the input tone value. In this embodiment, the selection candidate of the threshold matrix is specified by the processing of the flowchart shown in FIG. 11A and the correspondence table shown in FIG. 11B.

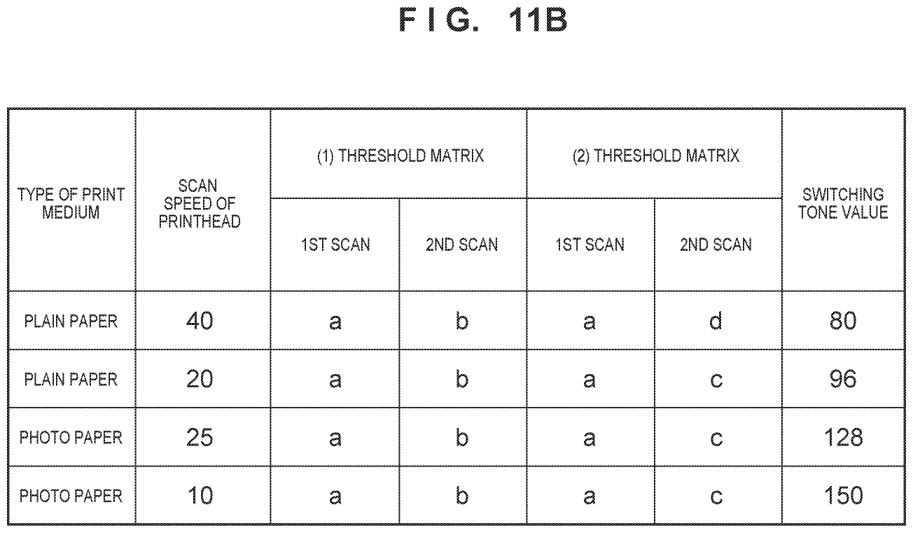

FIG. 13 is a view for explaining feature of an occurrence probability of dot-on-dot in each combination in a case where the threshold matrix a is used for one scan count, and the threshold matrices b, c, and d are used in the other scan count.

Dot-on-dot means that pixels to discharge dots overlap to form a single pixel on digital data between scans. It can be said that even on a print medium, dot-on-dot occurs at the same probability as on digital data in a state in which there is no influence of an inter-path misregistration or the like.

The occurrence probability of dot-on-dot is the ratio of the area of a region where dots between scans land in a superimposed manner by the discharge of the printhead to the area of a predetermined print region. On the other hand, the occurrence theoretical value of dot-on-dot represents overlap of dots generated by a combination in which the dot discharge data of scans do not have correlation with each other. The probability of the occurrence theoretical value of dot-on-dot is the ratio of the area of a region where pixels to discharge dots on digital data form a single pixel between scans to the area of a region on the digital data corresponding to a predetermined print region.

The occurrence theoretical value of dot-on-dot can be calculated by equation (1) using a combination formula in probability theory.

$${\sum }_{X = 0}^{D 1} \frac{{N}^{{C}_{D 1} {\times }_{D 1} {C}_{X} {\times }_{D 2} {C}_{X}}}{{N}^{{C}_{D 1} \times } {N}^{{C}_{D 2}}} \times \frac{X}{D 1} \qquad ( 1 )$$

In equation (1), N is the number of pixels corresponding to a certain print region of a print medium, D1 is the number of dots discharged by the first scan, D2 is the number of dots discharged by the second scan, and X is the number of pixels in which dot-on-dot occurs by the scan with two discharge operations. The sum of D1 and D2 equals N, and the condition of equation (1) is D1≤D2. Under such a condition, the dot-on-dot occurrence theoretical value can be evaluated. For example, assume that N=5, D1=dots of two discharge operations, and D2=dots of three discharge operations. For X=2 (dot-on-dot occurs in two of five pixels by the scan with two discharge operations), the calculation result is obtained as 0.3. Similarly, 0.3 is obtained for X=1, and 0 is obtained for X=0. When these calculation results are added, the dot-on-dot occurrence theoretical value is calculated as 0.6. Note that having correlation with each other between scans means that the condition of the denominator in equation (1) is different. Equation (1) shows the combination when discharging D1 and D2 at random from the number N of pixels. Unless at random, the combination probability varies.

FIG. 13 shows the probability distribution representing how much dot-on-dot between scans occurs when discharge is performed using the threshold matrix a in the first scan, and after that, discharge is performed in the second scan. Note that FIG. 13 assumes a case where the input tone value is distributed by 50% to each of the first scan and the second scan.

FIG. 13 assumes that in the first scan, ink is discharged to eight points of a print region of 4×4 pixels. At this time, the dot-on-dot occurrence theoretical value in the second scan is 50% (dot-on-dot for 8/16, and non-dot-on-dot for 8/16).

The threshold matrix b is designed to make the occurrence probability of dot-on-dot between scans much smaller than the dot-on-dot occurrence theoretical value such that dot-on-dot is distributed at an occurrence probability of about 10% on average. FIG. 13 shows a print region of 4×4 pixels. If the print region is wider than the print region of 4×4 pixels, the dot-on-dot occurrence probability is not always 10%, and may be less than 10% or may be 10% or more. Since a variation of the occurrence probability can be represented by a standard deviation, the occurrence probability can be expressed as a normal distribution. Since the dot-on-dot occurrence probability is smaller than the dot-on-dot occurrence theoretical value, it can be said that dots tend to be arranged exclusively (exclusive relationship) between scans, and have correlation with each other.

The threshold matrix c is designed to make the dot-on-dot occurrence probability smaller than the dot-on-dot occurrence theoretical value such that dot-on-dot is distributed at an occurrence probability of about 40% on average. The exclusive relationship between scans is weaker than between the threshold matrices a-b.

The threshold matrix d is designed to make the dot-on-dot occurrence probability close to the dot-on-dot occurrence theoretical value such that dot-on-dot is distributed at an occurrence probability of about 50% on average. It can be said that the dots do not have correlation between scans, and there is no consciousness of overlap.

That is, the threshold matrix b has the exclusive relationship with the threshold matrix a as compared to the threshold matrix c or threshold matrix d. In addition, deviation from the dot-on-dot occurrence theoretical value is largest in the combination of the threshold matrices a and b. That the deviation is large is represented by a value calculated from, for example, equation (2) below.

(dot-on-dot occurrence probability between scans when threshold matrices ◯−x is used)÷(dot-on-dot occurrence theoretical value between scans) (2)

Note that ◯−x in equation (2) represent some of the threshold matrices a to d here.

When the deviation is calculated based in equation (2) under the condition shown in FIG. 13, the following results are obtained.

Between threshold matrices a-b: 0.1÷0.5=0.2

Between threshold matrices a-c: 0.4÷0.5=0.8

Between threshold matrices a-d: 0.5÷0.5=1

Even for a different condition, the deviation from the dot-on-dot occurrence theoretical value between scans is substantially uniform, and the feature of the threshold matrix selectively used between scans depending on the input tone value can be expressed. Note that the distributions of dot-on-dot occurrence probability generated when using different threshold matrices include partially overlapping portions. However, because of the characteristic of the normal distribution, it is self-evident that the threshold matrices have different characteristics even if the ends of variations overlap. For example, when the statistical theory of a normal distribution is used, about 95% of generation results is included in a condition of σ=2. For this reason, overlap outside is not important when describing the characteristics of the threshold matrices.

Note that the calculation method of the dot-on-dot occurrence theoretical value is not limited to this. Regardless of the calculation method used for evaluation, the tendency of the dot-on-dot occurrence theoretical value matches the feature of non-correlation in which discharged dots in each scan do not have correlation with each other. For example, even in FIG. 13, the dot-on-dot occurrence theoretical value substantially matches between the threshold matrices a-d that are designed not to have correlation with each other. It is only necessary to have an index capable of evaluating the non-correlation state by a numeral value and evaluate the deviation from the dot-on-dot occurrence probability of dots discharged by two scans and actually measured on a print region. A thus obtained evaluation value is stored in a storage area such as the ROM of the image processing apparatus main control unit 108.

The same applies to a case where scan is performed three or more times for the same print region. If scan is performed three or more times, the calculation formula of the dot-on-dot occurrence theoretical value is more complex. However, dots discharged in each scan do not have correlation with each other between scans, like the above-described dot-on-dot occurrence theoretical value.

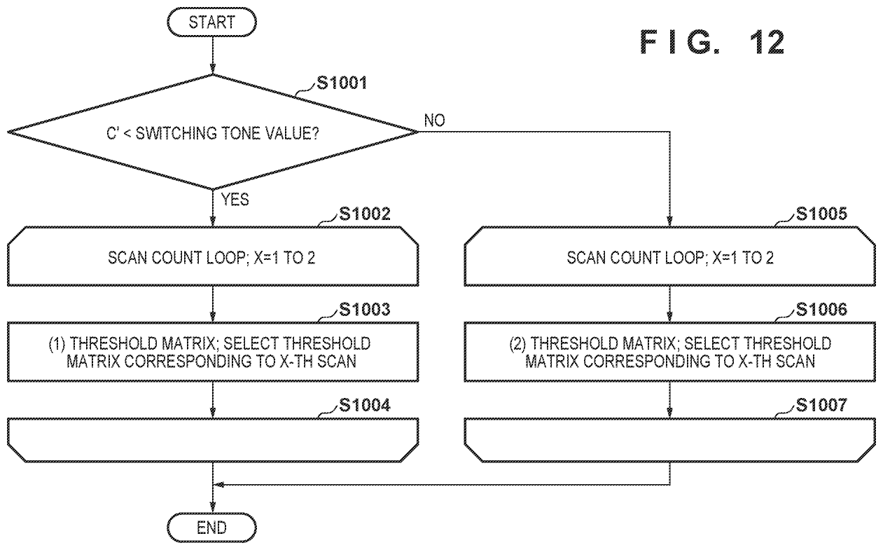

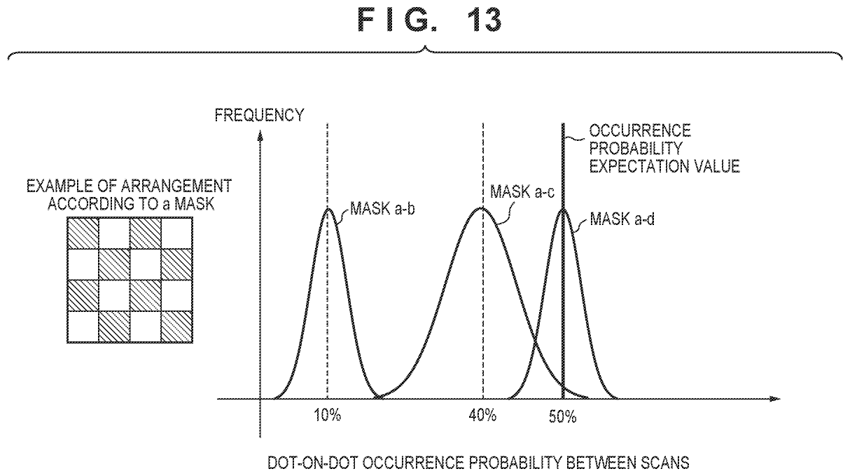

FIGS. 14A and 14B are views showing discharge distributions according to the threshold matrices used in scans, and show the influence of a misregistration between scans. In each graph, a dotted line indicates the first scan, and a solid line indicates the second scan.

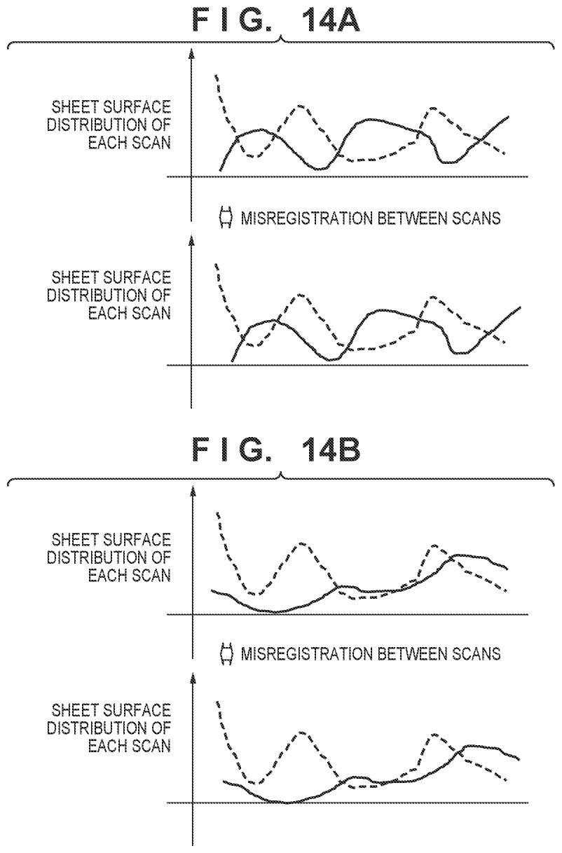

FIGS. 14A and 14B show a case where the input tone value is low, and FIGS. 15A and 15B show a case where the input tone value is high. Also, FIGS. 14A and 15A show a case where the scans have a strong exclusive relationship (have a correlation) with each other, and FIGS. 14B and 15B show a case where the scans have a weak exclusive relationship (have no correlation) with each other.

In each graph, the abscissa represents the X direction or the Y direction of the print medium. The ordinate represents the discharge distribution in each scan. If the value on the ordinate is high, it indicates that the density is high. If the value is low, it indicates that the density is low. Hence, a portion where the value on the ordinate is high represents that discharge is performed in that portion.

FIG. 14A shows a case where the input tone value is low, and a strong exclusive relationship is held between the first scan and the second scan. Hence, in an ideal state without a misregistration shown on the upper side of FIG. 14A, portions where the density is high in the second scan overlap portions where the density is low in the first scan. In a state in which a misregistration occurs in the second scan shown on the lower side of FIG. 14A, although the position of the solid line deviates, portions where the density is high in the first scan and portions where the density is high in the second scan do not overlap. Hence, if the landing positions between the scans have a strong exclusive relationship in the case where the input tone value is low, the density on the print medium is close to even, and a state with high graininess can be implemented. Also, even if a misregistration occurs, lightness evenness on the print medium is not lost, and therefore, robustness to the misregistration becomes high.

FIG. 14B shows a case where the input tone value is low, and a weak exclusive relationship is held between the first scan and the second scan. That is, it can be said that the scans have a relationship close to non-correlation with each other. Hence, both in an ideal state without a misregistration shown on the upper side of FIG. 14B and in a state with a misregistration shown on the lower side of FIG. 14B, portions where the density is high in both scans overlap at a certain probability. Since the state change is small independently of the presence/absence of a misregistration, it can be said that robustness to a misregistration is high. However, image quality lowers as compared to the case where the exclusive relationship is strong shown in FIG. 14A because portions where the density on the print medium is not even are included.

FIG. 15A shows a case where the input tone value is high, and a strong exclusive relationship is held between the first scan and the second scan. Hence, in an ideal state without a misregistration shown on the upper side of FIG. 15A, portions where the density is high in the second scan overlap portions where the density is low in the first scan. In a state in which a misregistration occurs in the second scan shown on the lower side of FIG. 15A, portions where the density is high in the first scan and portions where the density is high in the second scan overlap as a whole, and portions where the density is low in the first scan and portions where the density is low in the second scan overlap as a whole. In FIG. 15A, since the input tone value is high as compared to FIG. 14A, and therefore, the landing frequency of dots is high, a small misregistration causes inversion of lightness. Hence, it can be said that robustness to a misregistration is low. In FIG. 14A, since the input tone value is low, a large density difference is generated between a portion where the background color of the print medium can be seen and a portion where dots are discharged. In FIG. 15A, however, since the input tone value is high, the background color of the print medium is difficult to see. Hence, although lightness evenness on the print medium is lost because of dot overlap between the scans, the enhancement of the lightness difference is hardly a great factor of image quality deterioration.

FIG. 15B shows a case where the input tone value is high, and a weak exclusive relationship is held between the first scan and the second scan. That is, it can be said that the scans have a relationship close to non-correlation with each other. Hence, both in an ideal state without a misregistration shown on the upper side of FIG. 15B and in a state with a misregistration shown on the lower side of FIG. 15B, portions where the density is high in both scans overlap at a certain probability. Since the state change is small independently of the presence/absence of a misregistration, it can be said that robustness to a misregistration is high. In FIG. 15B, since the input tone value is high, the background color of the print medium is difficult to see. Hence, even if portions where the density is high overlap between the scans, the density difference is hardly a great factor of image quality deterioration, and a state with high graininess is maintained.

Thus, as shown in FIGS. 14A, 14B, 15A, and 15B, in a case where the input tone value is low, holding a strong exclusive relationship between scans is advantageous from the viewpoint of graininess and robustness. Also, in a case where the input tone value is high, holding a weak exclusive relationship between scans is advantageous from the viewpoint of graininess and robustness.

Each combination of threshold matrices defined in the correspondence table shown in FIG. 11B is defined as a combination of threshold matrices with excellent graininess and robustness. In this embodiment, in all conditions of print medium types and scan speeds of the printhead 102, threshold matrices used when the input tone value is low are common. That is, as shown in FIG. 11B, as the first threshold matrix, the threshold matrix a is used in the first scan, and the threshold matrix b is used in the second scan. As shown in FIG. 13 as well, in the combination of the threshold matrix a and the threshold matrix b, the occurrence probability of dot-on-dot largely deviates from the dot-on-dot occurrence theoretical value, and the exclusive relationship is strong. When the combination of threshold matrices with a strong exclusive relationship is used in a case where the input tone value is low, both the graininess and the robustness can simultaneously be ensured. On the other hand, as the threshold matrices used when the input tone value is high, combining the threshold matrix c or d with the threshold matrix a is defined. In these combinations, the occurrence probability of dot-on-dot does not so largely deviate from the dot-on-dot occurrence theoretical value, and the exclusive relationship is weak. That is, these have a relationship close to non-correlation with each other. In this embodiment, when the combination of threshold matrices with a weak exclusive relationship is used in a case where the input tone value is high, both the graininess and the robustness can simultaneously be ensured.

Since the distributions shown in FIGS. 14A, 14B, 15A, and 15B change depending on the conditions in printing, in this embodiment, a switching tone value is provided in correspondence with each setting information. For example, on plain paper, since ink permeability is high, and a dot easily spreads, as compared to photo paper, dot overlap begins to occur from a tone lower than on photo paper. Hence, the switching tone value for plain paper is set smaller than the switching tone value on photo paper. With this configuration, in a case where plain paper is used, the threshold matrix can be switched quickly to a threshold matrix of a weak exclusive relationship. In addition, when the scan speed of the printhead 102 is high, the landing accuracy is assumed to be low, and a deviation is assumed to occur strongly. For this reason, the switching tone value is set small for the high scan speed of the printhead 102. With this configuration, in a case where the scan speed of the printhead 102 is higher, the threshold matrix can be switched quickly to a threshold matrix of a weak exclusive relationship. That is, if a condition to cause a misregistration at high possibility is set, the threshold matrix is quickly switched to the second threshold matrix of a weak exclusive relationship by the lower switching tone value to prevent robustness to a misregistration from lowering.

The switching tone value is decided based on the spread of a dot on a print medium and the frequency/magnitude of a misregistration. In this embodiment, as the decision conditions, a print medium type and the scan speed of the printhead 102 are used. However, the conditions are not limited to these. Even on a print medium of a similar type, the spread of a dot changes depending on the ink permeability difference and the type of ink to be discharged. Also, the frequency/magnitude of a misregistration changes depending on the distance between the printhead 102 and the print medium, the scan count of the printhead 102, and whether the print region is located at an end portion of the print medium or at the center. If the distance between the printhead 102 and the print medium is long, the landing accuracy lowers. For this reason, the frequency of a deviation becomes high, and the deviation amount becomes large. Depending on the specifications of the main body of the printing apparatus 1, as a characteristic of an end portion of a print medium, the print medium readily flaps because of weak press of a conveyance roller. This makes the frequency of a deviation high and the deviation amount large. The switching tone value may be decided by combining the plurality of conditions described above. Note that in this embodiment, even for plain paper, the combination of threshold matrices to be used is changed in accordance with the scan speed of the printhead 102. In a mode in which the scan speed of the printhead 102 is low, set contents on a printer driver often include “high quality”. Graininess is important for a user who demands high quality. For this reason, in this embodiment, the combination of the threshold matrix a and the threshold matrix c is used. This is because, as shown in FIG. 13, the combination of the threshold matrix a and the threshold matrix c ensures high graininess in a non-misregistration state as compared to the combination of the threshold matrix a and the threshold matrix d.

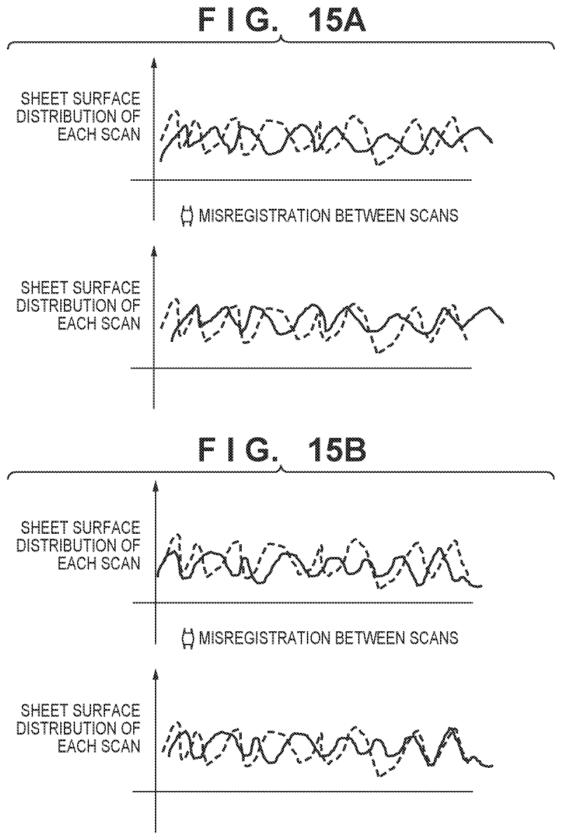

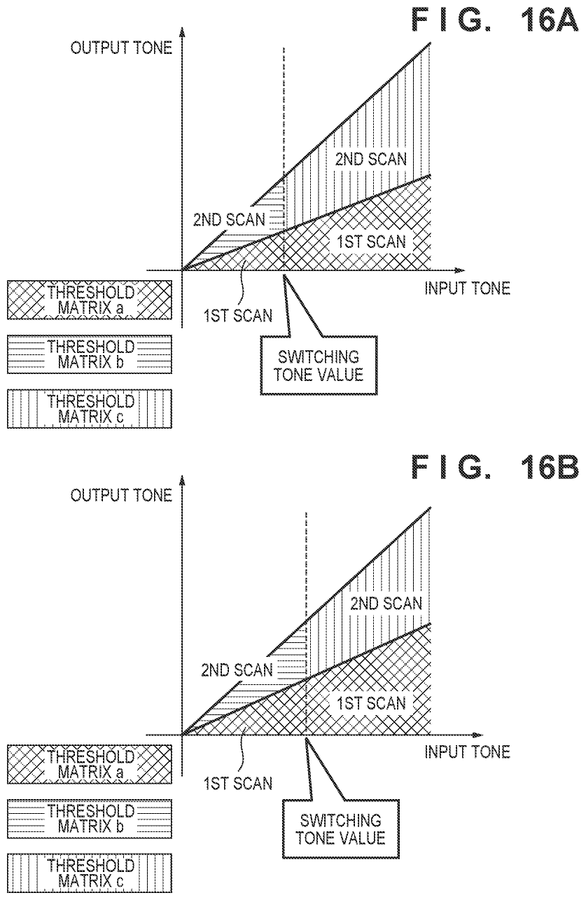

FIGS. 16A and 16B show selection of threshold matrices corresponding to an input tone value in this embodiment. FIG. 16A shows a case where the pieces of setting information are “print medium type=plain paper, and scan speed of printhead 102=20 inches/sec”. In the first scan, even if the input tone value increases and passes through the switching tone value, same threshold matrices are continuously used. On the other hand, in the second scan, different threshold matrices are used after the input tone value increases and passes through the switching tone value. FIG. 16B shows a case where the pieces of setting information are “print medium type=photo paper, and scan speed of printhead 102=25 inches/sec”. Although threshold matrix selection is the same as in FIG. 16A, the switching tone value is set larger.

The switching tone value may be decided from a range based on the input tone value. Considering that registration deviates by an amount corresponding to one pixel at maximum, and that a dot spreads by an amount corresponding to one pixel at maximum, the possibility of graininess lowering and lightness inversion is considered to be high in a case where dots are arranged on eight pixels around a target pixel. Hence, a predetermined switching tone value may be decided within a tone value range (=about 10%) about 1/9 the highest input tone value.

Here, concerning the predetermined switching tone value, the lower tone side of the switching tone value is defined as a first range, and the higher tone side of the switching tone value is defined as a second range. If the range of a tone value is from 0 to 255, and the switching tone value is 80, the first range is from 0 to 79, and the second range is from 81 to 255. Dot-on-dot occurrence probability÷dot-on-dot occurrence theoretical value in a case where the input tone value is included in the first range is smaller than dot-on-dot occurrence probability÷dot-on-dot occurrence theoretical value in a case where the input tone value is included in the second range.

In the example shown in FIG. 16A, if the input tone value is included in the first range, dot discharge data is generated by the combination of the threshold matrix a and the threshold matrix b. For example, the input tone value is defined as a first tone value (for example, 50). First, the scan count division unit 401 generates tone values C1′=25 and C2′=25 corresponding to two scans. Since the first tone value (50) is a value included in the first range (0 to 79), the tone value C1′ (25) corresponding to the first scan is quantized using the threshold matrix a, and a first dot arrangement is generated. Similarly, the tone value C2′ (25) corresponding to the second scan is quantized using the threshold matrix b, and a second dot arrangement is generated. Here, the ratio of the number of pixels that overlap as the result of quantization using the threshold matrix a and the threshold matrix b to the total number of pixels in the first dot arrangement and the second dot arrangement in a case where overlap is assumed to be absent is defined as a first ratio.

On the other hand, if the input tone value is included in the second range, dot discharge data is generated by the combination of the threshold matrix a and the threshold matrix c. For example, the input tone value is defined as a second tone value (for example, 250). First, the scan count division unit 401 generates tone values C1′=125 and C2′=125 corresponding to two scans. Since the second tone value (250) is a value included in the second range (81 to 255), the tone value C1′ (125) corresponding to the first scan is quantized using the threshold matrix a, and a third dot arrangement is generated. Similarly, the tone value C2′ (125) corresponding to the second scan is quantized using the threshold matrix c, and a fourth dot arrangement is generated. Here, the ratio of the number of pixels that overlap as the result of quantization using the threshold matrix a and the threshold matrix c to the total number of pixels in the third dot arrangement and the fourth dot arrangement in a case where overlap is assumed to be absent is defined as a second ratio.

In the above-described example, the first ratio is 5/100 because this is the ratio of the number of pixels (for example, 5) that overlap as the result of quantization using the threshold matrix a and the threshold matrix b to the total number of pixels (100) in the first dot arrangement and the second dot arrangement in a case where overlap is assumed to be absent. On the other hand, the second ratio is 100/250 because this is the ratio of the number of pixels (for example, 100) that overlap as the result of quantization using the threshold matrix a and the threshold matrix c to the total number of pixels (250) in the third dot arrangement and the fourth dot arrangement in a case where overlap is assumed to be absent. The first ratio and the second ratio each show that the lower the ratio is, the lower the dot-on-dot occurrence probability is, and the stronger the exclusive relationship is. As shown in the above-described example, the combination of threshold matrices according to this embodiment is set such that the first ratio is lower than the second ratio. That is, the example shows that the dot-on-dot occurrence probability in a case where the input tone value is lower than the switching tone value is lower than the dot-on-dot occurrence probability in a case where the input tone value is higher than the switching tone value.

Note that since only needed is to compare the strengths of exclusive relationships suffices, the indices are not limited to those described above. For example, the ratio of the number of pixels that do not overlap as the result of quantization using threshold matrices to the total number of pixels in a case where overlap is assumed to be absent may be used. In this case, the dot-on-dot occurrence probability on the low tone side can be lowered by making the ratio for a tone value lower than the switching tone value higher than the ratio for a tone value higher than the switching tone value.

Note that as described above, the calculation method of the dot-on-dot occurrence theoretical value is not limited to this. Also, the dot-on-dot occurrence theoretical value equals that when dots discharged between scans do not have correlation with each other.

According to this embodiment, threshold matrices are selectively controlled, thereby obtaining a state in which high graininess is ensured while minimizing the influence of an inter-scan misregistration. Also, when selection of threshold matrices and change of the switching tone value of threshold matrices are performed in accordance with the setting information, it is possible to cope with a variety of print conditions by the same control. Even for print conditions with which a dot spreads in a different manner, same threshold matrices can be used only by changing the switching tone value. For example, same threshold matrices can be used only by changing the switching tone value between a case where the pieces of setting information are “print medium type=photo paper, and scan speed of printhead 102=10 inches/sec” and a case where the pieces of setting information are “print medium type=photo paper, and scan speed of printhead 102=25 inches/sec”. Hence, the capacity of the RAM can be suppressed.

In this embodiment, a case where the scan count for completing printing on a predetermined unit region is 2 has been described. The same applies to a case where the scan count is larger. A combination of threshold matrices with a strong or weak exclusive relationship between scans can be selected. In this case, the scan count division unit 401 generates data as many as the scan count.

A plurality of switching tone values may be set. For example, selection of threshold matrices may be switched between a case where the input tone value represents a low density, a case where the input tone value represents a halftone, and a case where the input tone value represents a high density. In a halftone, the influence of a misregistration is large. However, when the density is high, the density difference is substantially unchanged even if dot-on-dot occurs due to a misregistration. Hence, when the combination of the threshold matrix a and the threshold matrix c is used for a halftone, and the combination of the threshold matrix a and the threshold matrix d is used for a high density, a dot arrangement suitable for each tone can be implemented.

Also, in the above-described example, if the input tone value is 50, the scan count division unit 401 generates two data of a tone value “25”. However, the present invention is not limited to the example in which data is equally divided to generate a plurality of data having equal tone values, and the ratio may appropriately be changed. When equally dividing data, one data may be generated and quantized using the combination of selected threshold matrices to generate data representing a dot arrangement.

### Second Embodiment

Concerning the second embodiment, differences from the first embodiment will be described below. In the first embodiment, using a switching tone value to set threshold matrices to be used in each scan before and after the switching tone value has been described. The strength of the exclusive relationship (correlation) is controlled using the threshold matrices set before and after the switching tone value. For example, a strong exclusive relationship is implemented using the combination of the threshold matrix a and the threshold matrix b. When creating an exclusive relationship using threshold matrices, for a portion where a threshold is set low in one threshold matrix, a threshold assigned to the same position in the other threshold matrix is set high, thereby implementing the exclusive relationship.

In this embodiment, the exclusive relationship is implemented not only by the combination of threshold matrices by also by exclusion by control based on one threshold matrix. This can obviate the necessity of preparing a plurality of different threshold matrices and reduce the memory capacity. Also, even if the scan count increases, the threshold setting can be prevented from becoming complex.

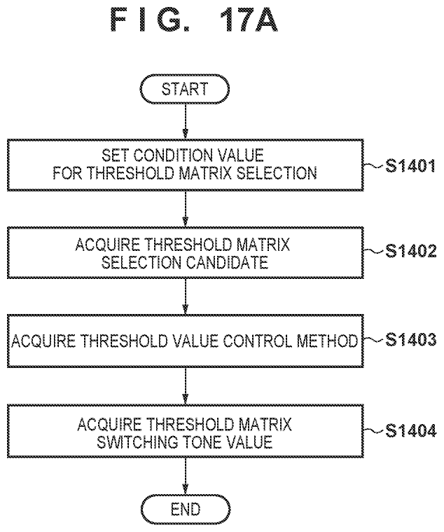

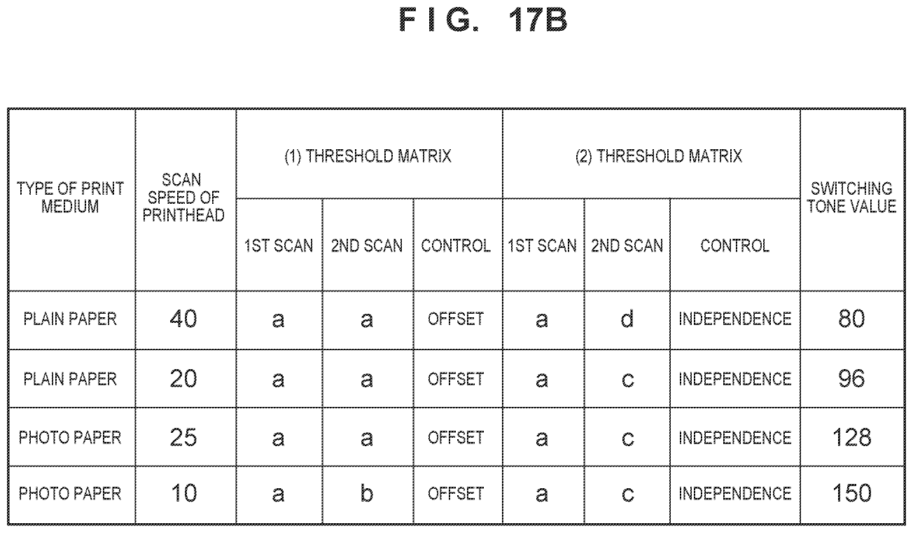

FIG. 17A is a flowchart showing threshold matrix candidate selection processing according to this embodiment. The processing shown in FIG. 17A is implemented by a CPU provided in an image processing apparatus main control unit 108 reading out a program stored in a ROM and executing it.

In step S1401, a threshold acquisition unit 406 acquires setting information for threshold matrix selection. In this embodiment, the type of a print medium that is a print target and the scan speed of a printhead 102 are acquired. For example, pieces of setting information (print conditions) such as print medium type=plain paper and scan speed of printhead 102=40 inches/sec are acquired. The setting information may be acquired from, for example, contents set by the user. The scan speed of the printhead 102 may be held in an internal storage area in advance, or may be acquired from a printing apparatus 1.

In step S1402, the threshold acquisition unit 406 acquires a threshold matrix selection candidate corresponding to the setting information based on a correspondence table shown in FIG. 17B. For example, for the above-described setting information, a threshold matrix a is acquired as a threshold matrix selection candidate for the first scan, and the threshold matrix a and a threshold matrix d are acquired for the second scan.

In step S1403, the threshold acquisition unit 406 acquires a threshold control method based on the correspondence table shown in FIG. 17B.

FIG. 17B shows an example of the correspondence table to be referred to by the threshold acquisition unit 406 in steps S1402 and S1403. In the correspondence table, a first threshold matrix and a second threshold matrix are registered for each setting information, as in FIG. 11B. Both the first threshold matrix and the second threshold matrix include the item of a control method, and one of an “offset mode” and an “independent mode” is set. As in the first embodiment, the first threshold matrix is selected for a tone value smaller than the switching tone value, and the second threshold matrix is selected for a tone value equal to or larger than the switching tone value. Additionally, in this embodiment, selection of a threshold matrix in each scan in a case where a tone value is smaller than the switching tone value is performed in the offset mode, and selection of a threshold matrix in each scan in a case where a tone value is equal to or larger than the switching tone value is performed in the independent mode.

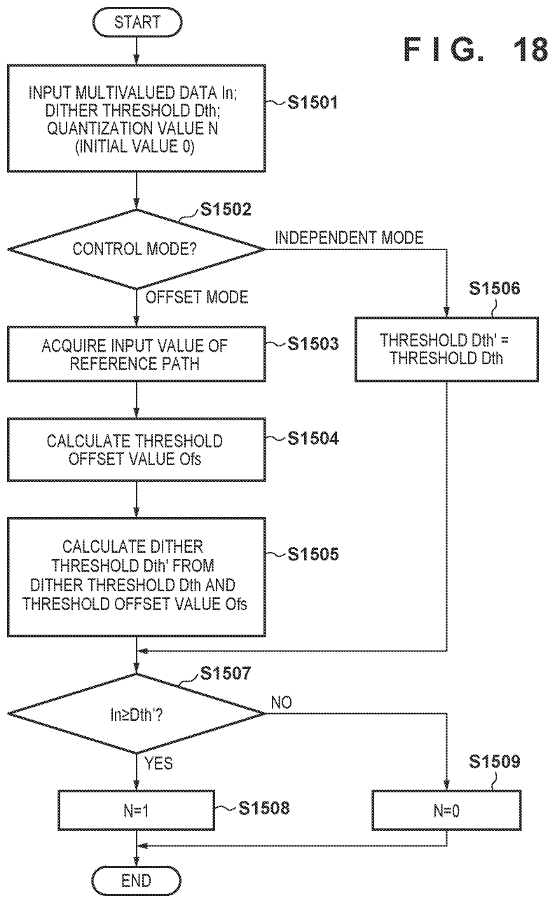

FIG. 18 is a flowchart showing quantization processing according to this embodiment. The processing shown in FIG. 18 is executed by a quantization processing unit 407 in a dither processing unit 402.

If input multivalued data In of one pixel is input, in step S1501, the quantization processing unit 407 prepares a dither threshold Dth. The prepared threshold Dth is a threshold assigned to each scan in FIG. 12 in accordance with the combination of threshold matrices selected in FIG. 17B. For example, in a case where print medium type=plain paper and scan speed of printhead 102=40 inches/sec, if the input tone value is 50, it is smaller than the switching tone value, and therefore, a threshold matrix a is assigned to the first scan, and the threshold matrix a is assigned to the second scan. Also, since the input tone value is equally distributed to the scans, input multivalued data In of first scan=25, and input multivalued data In of second scan=25.

In step S1502, the quantization processing unit 407 determines the control method of a target pixel. As shown in FIG. 17B, the offset mode and the independent mode are defined as the control method. If pieces of setting information are print medium type=plain paper and scan speed of printhead 102=40 inches/sec, as described above, the offset mode is determined for input tone value=50. For this reason, the process advances from step S1502 to step S1503. Note that if the input tone value is 80 or more, the independent mode is determined, and the process advances from step S1502 to step S1506.

In step S1503, the quantization processing unit 407 acquires the input value of scan of the reference destination. For example, in this embodiment, assume that the scan count is 2, and for the second scan, the input value of the first scan is referred to. Hence, scan of the reference destination does not exist for the first scan, and the input value of the first scan is acquired for the second scan.

In step S1504, the quantization processing unit 407 acquires a threshold offset value Ofs from the acquired input value of the scan of the reference destination. The threshold offset value Ofs is calculated by equation (3).

Ofs=sum of input values of scan of reference destination (3)

Hence, Ofs=0 for the first scan. For the second scan, the input value of the first scan is referred to. Hence, if input value of first scan=25, Ofs=25. In this embodiment, a case where the scan count is 2 is shown. The same applies to a larger scan count. If the scan count is 2 or more, the sum of the input values of scan of all reference destinations is acquired as Ofs.

In step S1505, the quantization processing unit 407 calculates a dither threshold Dth′ from the dither threshold Dth and the threshold offset value Ofs. The dither threshold Dth′ is calculated by equations (4) and (5).

Dth′=Dth−Ofs (4)

If Dth′<0,

Dth′=Dth′+Dth_Max (5)

At this time, Dth_Max represents the maximum value of the range (0 to Dth_Max) of values that Dth can take.

On the other hand, if the process advances from step S1502 to step S1506, the quantization processing unit 407 substitutes the contents of the dither threshold Dth into the dither threshold Dth′.

In step S1507, the quantization processing unit 407 performs a comparison operation between the calculated Dth′ and the input multivalued data In. The processes of steps S1508 and S1509 are the same as those of steps S503 and S504, and a description thereof will be omitted.

When the quantization processing shown in FIG. 18 is executed, the exclusive relationship between scans can be controlled. For example, assume that input value of first scan=25, input value of second scan=25, the threshold Dth corresponding to the pixel position is 40, and Dth_Max is 255. At this time, for the first scan, since Dth is larger than the input value, the quantization result is On the other hand, for the second scan, Dth′ is 40-25=15 in accordance with equations (4) and (5). Since the input value is larger than Dth′, the quantization result is 1. Even if the same threshold matrix is used, dots can exclusively be arranged using the threshold offset value using the input value of the scan of the reference destination. Also, according to the configuration of this embodiment, even if the scan count is 3 or more, the threshold offset value Ofs for each scan can easily be calculated. In addition, since it is unnecessary to design threshold matrices having the exclusive relationship, design difficulty is reduced, and the capacity of the RAM can also be suppressed.

FIG. 19 is a view showing selection of threshold matrices corresponding to an input tone value in this embodiment. FIG. 19 shows a case where the pieces of setting information are print medium type=plain paper, and scan speed of printhead 102=20 inches/sec. In the first scan, even if the input tone value increases and passes through the switching tone value, same threshold matrices are continuously used. On the other hand, in the second scan, different threshold matrices are used after the input tone value increases and passes through the switching tone value. In the second scan, if a tone is lower than the switching threshold, the exclusive relationship with the first scan is implemented by the offset mode using the same threshold matrix as in the first scan. On the other hand, if a tone is higher than the switching tone value, as described in the first embodiment, the independent mode using a threshold matrix different from that in the first scan is used, thereby implementing a relationship with which the dot arrangement has a relationship close to non-correlation with that in the first scan.

As described above, according to this embodiment, threshold matrices having the exclusive relationship between scans can be implemented using one threshold matrix. Note that in this embodiment, the threshold of the threshold matrix is offset. However, a method of offsetting a tone value in the second and subsequent scans may be used. Change processing of offsetting (adding or subtracting) at least one of multivalued data and a threshold matrix is performed, and quantization is performed using the multivalued data and the threshold matrix after the change processing. Even in a case where a plurality of quantization processes corresponding to a plurality of scans are performed using one threshold matrix, dot arrangements having the exclusive relationship with each other can be obtained by performing offset processing.

### Third Embodiment

The third embodiment will be described in terms of differences from the first and second embodiments. As shown in FIG. 19, an input tone value is equally distributed to scans to execute dot formation of each scan in the above embodiments. However, in a case where an input tone value is equally distributed to scans, the change of the dot arrangement may be noticeable when using different threshold matrices before and after the switching tone value. For example, assume that the switching tone value is 80. If the threshold matrix is not switched before and after the switching tone value, the dot arrangement hardly changes between an input tone value “79” and the input tone value “80”. The dot arrangement for the input tone value “79” is included in the dot arrangement for the input tone value “80” although the number of dots after quantization is larger because of the increase in the input tone value. However, if a threshold matrix a changes to a threshold matrix c before and after the switching tone value, the dot arrangement for the input tone value “79” is not included in the dot arrangement for the input tone value “80”. For example, in an input image in which the pixel value transitions and increases like a gradation, switching of the threshold matrix occurs halfway through, and the change of the dot arrangement as described above may be conspicuous. In this embodiment, a configuration for reducing the above-described phenomenon caused by threshold matrix switching that occurs before and after the switching tone value will be described.

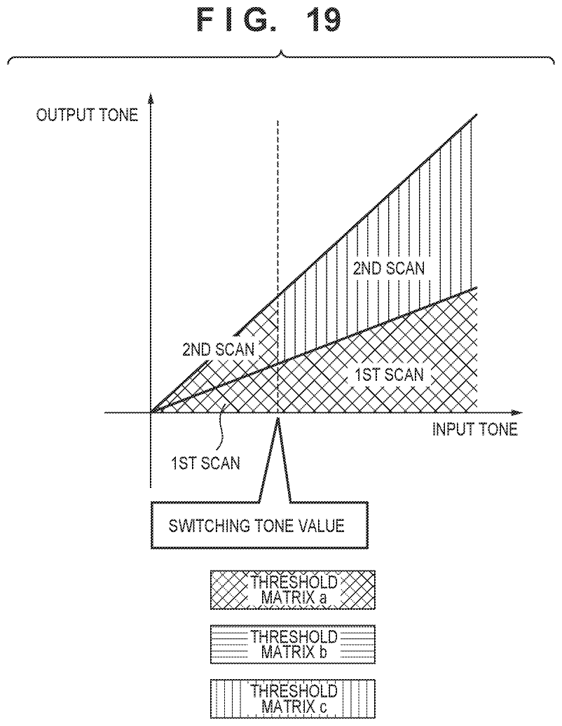

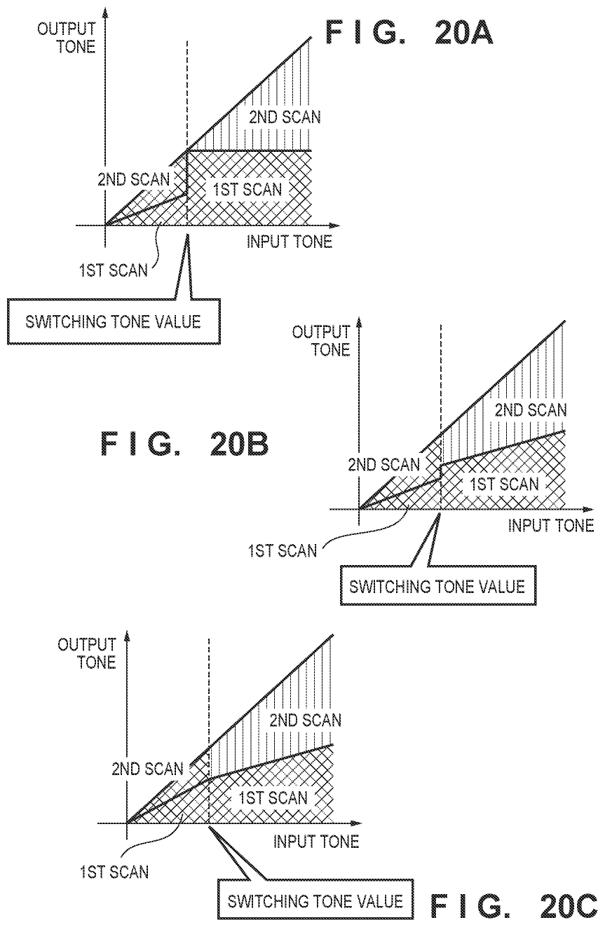

FIGS. 20A to 20C show selection of threshold matrices corresponding to an input tone value in this embodiment. Note that the types of threshold matrices shown in FIGS. 20A to 20C are the same as in FIG. 19.

In FIG. 20A, as for the tone up to the switching tone value, the input tone value is distributed in an equal ratio to the first scan and the second scan. Immediately after the switching tone value, the most part of the input tone value is assigned to the first scan. As the input tone value becomes high, the distribution ratio to the second scan increases. In this configuration, a result in which the dot arrangement is substantially unchanged before and after the switching tone value can be obtained. For example, if the switching tone value is 80, the input tone value “80” is substantially wholly assigned to the first scan, and the threshold matrix a is used. For the input tone value “79”, the threshold matrix a is set for both the first scan and the second scan. That is, since the same threshold matrix is used before and after the switching tone value, switching is unnoticeable. Also, as for the input tone value after the switching tone value, the ratio for the second scan gradually increases, and therefore, even if the dot arrangement of the threshold matrix c starts, the change of the dot arrangement hardly becomes conspicuous.

In FIG. 20B, the change of the distribution ratio between scans after the switching tone value, that is, the degree of the increase of the distribution ratio for the second scan is less steep than in FIG. 20A. If discharge is concentrated to one of the scans, the discharge tolerance of nozzles used in the other scan may be reflected on a print medium. When the distribution ratio between scans is set as shown in FIG. 20B, unevenness on the print medium caused by the discharge tolerance of the nozzles can be reduced.

In FIG. 20C, to make the change of the distribution ratio smoother that in FIG. 20B, the distribution ratio between scans is set unevenly from the tone on the lower side of the switching tone value, that is, such that the distribution ratio to the first scan becomes large. If the scan count is 2, in some cases, the first scan of a printhead 102 is performed in the forward direction in the X direction, and the second scan is performed in the backward direction. The landing position of a dot delicately deviates depending on the scanning direction of the printhead 102, and the manner satellite droplets fly changes. For this reason, the difference depending on the scanning direction is unnoticeable when the density assigned to each scan gradually changes. Hence, even if the density is concentrated to the first scan from before the switching tone value, and the distribution ratio after the switching tone value is uneven, control can be done such that the density ratio between the scans does not extremely change.

As described above, when a scan count division unit 401 unevenly assigns the input tone value to the scans, a conspicuous change of the dot arrangement before and after the switching tone value can be suppressed. As shown in FIGS. 20A to 20C, as the input tone value becomes large, the distribution ratio to a certain scan tends to increase. As for the distribution ratios shown in FIGS. 20A to 20C, for example, the distribution ratio may be decided by an operation for the input tone value, or the distribution ratio may be managed in linking with the input tone value using an LUT.

### OTHER EMBODIMENTS

In the above-described embodiments, all processes shown in FIG. 4 are executed by the image processing apparatus 2. However, each process shown in FIG. 4 may be performed by any apparatus if it is performed in the printing system shown in FIG. 1. For example, processes up to the scan count division processing in step S305 may be executed by the image processing apparatus 2, and the quantization processing in step S306 may be executed by the printing apparatus 1. Also, the printing apparatus 1 may have the function of the image processing apparatus 2 and execute all processes from step S301. In this case, the printing apparatus 1 operates as the image processing apparatus 2 according to each embodiment.

The number of bits of input/output in each process described above is not limited to that of the above-described embodiments. To maintain accuracy, the number of outputs bits may be larger than the number of input bits, and the number of bits may be adjustable variously in accordance with the application purpose or situation.

Furthermore, an inkjet printing apparatus has been described above as a configuration for printing an image processed by quantization. However, the configuration is not limited to the inkjet printing apparatus. The operation of each embodiment can be applied to any printing method if a plurality of levels of densities according to the level after multivalued quantization can be expressed in each pixel. For example, even in an apparatus that prints an image by an electrophotographic method, if a density according to a level after quantization can be expressed in each pixel by adjusting the output value of a laser to several levels, the operation of each embodiment can be applied to obtain the same effect.

Embodiment(s) of the present invention can also be realized by a computer of a system or apparatus that reads out and executes computer executable instructions (e.g., one or more programs) recorded on a storage medium (which may also be referred to more fully as ‘a non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-096751, filed Jun. 15, 2022, which is hereby incorporated by reference herein in its entirety.

What is claimed is:

1. An image processing apparatus comprising:
an input unit configured to input image data;
a generation unit configured to generate, from the image data input by the input unit, print data to be used in each of a plurality of scans of a printing unit;
an acquisition unit configured to acquire a threshold matrix based on a tone value represented by the image data; and
a quantization unit configured to execute quantization processing for the print data using the threshold matrix acquired by the acquisition unit,
wherein if the tone value is included in a first range, the acquisition unit acquires a first threshold matrix corresponding to a first scan of the plurality of scans and acquires a second threshold matrix corresponding to a second scan, and if the tone value is included in a second range on a higher tone side of the first range, the acquisition unit acquires a third threshold matrix corresponding to the first scan and acquires a fourth threshold matrix corresponding to the second scan,
the quantization unit executes the quantization processing for first print data corresponding to the first scan using the first threshold matrix and the third threshold matrix, and executes the quantization processing for second print data corresponding to the second scan using the second threshold matrix and the fourth threshold matrix, and
a first degree that a dot arrangement that is a result of quantization using the third threshold matrix and a dot arrangement that is a result of quantization using the fourth threshold matrix hold an exclusive relationship is smaller than a second degree that a dot arrangement that is a result of quantization using the first threshold matrix and a dot arrangement that is a result of quantization using the second threshold matrix hold the exclusive relationship.

2. The apparatus according to claim 1, wherein the first degree and the second degree are each expressed as a ratio of the number of pixels that overlap as a result of quantization using different threshold matrices to the total number of pixels in a dot arrangement that is a result of quantization using the different threshold matrices in a case where overlap is assumed to be absent.

3. The apparatus according to claim 1, wherein
the input unit acquires a print condition in printing of the image data, and
the first range and the second range are decided in accordance with the print condition.

4. The apparatus according to claim 1, wherein the first threshold matrix and the third threshold matrix are identical threshold matrices.

5. The apparatus according to claim 3, wherein
the first range and the second range do not overlap and are switched via a switching tone value, and
the switching tone value in a case where the print condition is a first print condition and the switching tone value in a case where the print condition is a second print condition are different.

6. The apparatus according to claim 5, wherein the switching tone value in the case where the print condition is the first print condition is smaller than the switching tone value in the case where the print condition is the second print condition.

7. The apparatus according to claim 6, wherein an overlap amount of dots between scans under the first print condition is larger than an overlap amount of dots between scans under the second print condition.

8. The apparatus according to claim 7, wherein ink permeability is higher for a type of a print medium defined by the first print condition than for a type of a print medium defined by the second print condition.

9. The apparatus according to claim 7, wherein a scan speed of the printing unit defined by the first print condition is higher than a scan speed of the printing unit defined by the second print condition.

10. The apparatus according to claim 1, further comprising a memory configured to store the first threshold matrix and the second threshold matrix.

11. The apparatus according to claim 1, wherein the second threshold matrix is generated by changing thresholds of the first threshold matrix.

12. The apparatus according to claim 1, further comprising an assignment unit configured to assign a tone value represented by the print data to the first print data and the second print data at a predetermined ratio.

13. The apparatus according to claim 12, wherein the assignment unit assigns the tone value to the first print data and the second print data at an equal ratio.

14. The apparatus according to claim 12, wherein in the first range, a ratio of the tone value assigned to the first print data by the assignment unit is larger than a ratio of the tone value assigned to the second print data.

15. The apparatus according to claim 12, wherein in the second range close to switching from the first range, a ratio of the tone value assigned to the first print data by the assignment unit is larger than a ratio of the tone value assigned to the second print data.

16. The apparatus according to claim 1, further comprising an output unit configured to output, to the printing unit, the data for which the quantization processing is executed by the quantization unit.

17. The apparatus according to claim 1, further comprising the printing unit.

18. The apparatus according to claim 1, wherein the plurality of scans are two scans.

19. The apparatus according to claim 1, wherein each of the first degree that the dot arrangements of the first threshold matrix and the second threshold matrix have the exclusive relationship and the second degree that the dot arrangements of the third threshold matrix and the fourth threshold matrix have the exclusive relationship is stored as an evaluation value of dot overlap measured in advance.

20. An image processing method comprising:
inputting image data;
generating, from the input image data, print data to be used in each of a plurality of scans of a printing unit;
acquiring a threshold matrix based on a tone value represented by the image data; and
executing quantization processing for the print data using the acquired threshold matrix,
wherein if the tone value is included in a first range, a first threshold matrix corresponding to a first scan of the plurality of scans is acquired, and a second threshold matrix corresponding to a second scan is acquired, and if the tone value is included in a second range on a higher tone side of the first range, a third threshold matrix corresponding to the first scan is acquired, and a fourth threshold matrix corresponding to the second scan is acquired, and
a first degree that a dot arrangement that is a result of quantization using the third threshold matrix and a dot arrangement that is a result of quantization using the fourth threshold matrix hold an exclusive relationship is smaller than a second degree that a dot arrangement that is a result of quantization using the first threshold matrix and a dot arrangement that is a result of quantization using the second threshold matrix hold the exclusive relationship.

21. A non-transitory computer-readable storage medium storing a program configured to cause a computer of an information processing apparatus to function to:
input image data;
generate, from the input image data, print data to be used in each of a plurality of scans of a printing unit;
acquire a threshold matrix based on a tone value represented by the image data; and
execute quantization processing for the print data using the acquired threshold matrix,
wherein if the tone value is included in a first range, a first threshold matrix corresponding to a first scan of the plurality of scans is acquired, and a second threshold matrix corresponding to a second scan is acquired, and if the tone value is included in a second range on a higher tone side of the first range, a third threshold matrix corresponding to the first scan is acquired, and a fourth threshold matrix corresponding to the second scan is acquired, and
a first degree that a dot arrangement that is a result of quantization using the third threshold matrix and a dot arrangement that is a result of quantization using the fourth threshold matrix hold an exclusive relationship is smaller than a second degree that a dot arrangement that is a result of quantization using the first threshold matrix and a dot arrangement that is a result of quantization using the second threshold matrix hold the exclusive relationship.

22. An image processing apparatus comprising:
an input unit configured to input image data;
a generation unit configured to generate, from the image data input by the input unit, print data to be used in each of a plurality of scans, including a first scan and a second scan, of a printing unit; and
a quantization unit configured to perform, using a threshold matrix, quantization processing for the print data corresponding to each of the plurality of scans,
wherein if a tone value represented by the image data is included in a first range, the quantization unit acquires first quantized data corresponding to the first scan by performing the quantization processing using the print data corresponding to the first scan and a first threshold matrix, and acquires second quantized data corresponding to the second scan by offsetting at least one of the print data to be printed by the second scan and the first threshold matrix using the print data corresponding to the first scan and performing the quantization processing using the print data and the first threshold matrix after the offset, and
if the tone value represented by the image data is included in a second range on a higher tone side of the first range, the quantization unit acquires third quantized data corresponding to the first scan by performing the quantization processing using the print data corresponding to the first scan and the first threshold matrix, and acquires fourth quantized data corresponding to the second scan by performing the quantization processing using the print data corresponding to the second scan and a second threshold matrix different from the first threshold matrix.

23. The apparatus according to claim 22, wherein the quantization unit performs the offset by subtracting the print data corresponding to the first scan from the first threshold matrix.

24. The apparatus according to claim 22, wherein the quantization unit performs the offset by adding the print data corresponding to the first scan to the print data corresponding to the second scan.

25. The apparatus according to claim 22, wherein
a ratio of the number of pixels that overlap between a first dot arrangement of the first quantized data and a second dot arrangement of the second quantized data to the total number of pixels in a dot arrangement in a case where overlap is assumed to be absent between the first dot arrangement and the second dot arrangement is defined as a first ratio,
a ratio of the number of pixels that overlap between a third dot arrangement of the third quantized data and a fourth dot arrangement of the fourth quantized data to the total number of pixels in a dot arrangement in a case where overlap is assumed to be absent between the third dot arrangement and the fourth dot arrangement is defined as a second ratio, and
the first ratio is lower than the second ratio.

26. An image processing method comprising:
inputting image data;
generating, from the input image data, print data to be used in each of a plurality of scans, including a first scan and a second scan, of a printing unit; and
performing, using a threshold matrix, quantization processing for the print data corresponding to each of the plurality of scans,
wherein if a tone value represented by the image data is included in a first range, first quantized data corresponding to the first scan is acquired by performing the quantization processing using the print data corresponding to the first scan and a first threshold matrix, and second quantized data corresponding to the second scan is acquired by offsetting at least one of the print data to be printed by the second scan and the first threshold matrix using the print data corresponding to the first scan and performing the quantization processing using the print data and the first threshold matrix after the offset, and
if the tone value represented by the image data is included in a second range on a higher tone side of the first range, third quantized data corresponding to the first scan is acquired by performing the quantization processing using the print data corresponding to the first scan and the first threshold matrix, and fourth quantized data corresponding to the second scan is acquired by performing the quantization processing using the print data corresponding to the second scan and a second threshold matrix different from the first threshold matrix.

27. The method according to claim 26, wherein the offset is performed by subtracting the print data corresponding to the first scan from the first threshold matrix.

28. The method according to claim 26, wherein the offset is performed by adding the print data corresponding to the first scan to the print data corresponding to the second scan.

29. The method according to claim 26, wherein
a ratio of the number of pixels that overlap between a first dot arrangement of the first quantized data and a second dot arrangement of the second quantized data to the total number of pixels in a dot arrangement in a case where overlap is assumed to be absent between the first dot arrangement and the second dot arrangement is defined as a first ratio,
a ratio of the number of pixels that overlap between a third dot arrangement of the third quantized data and a fourth dot arrangement of the fourth quantized data to the total number of pixels in a dot arrangement in a case where overlap is assumed to be absent between the third dot arrangement and the fourth dot arrangement is defined as a second ratio, and
the first ratio is lower than the second ratio.
